(19) United States
(12) Patent Application Publication
(10) Pub. No.: US 2008/0297631 A1
(43) Pub. Date: Dec. 4, 2008

(54) SOLID-STATE IMAGING CIRCUIT AND CAMERA SYSTEM

(75) Inventor: Hiroshi DAIKU, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/130,645

(22) Filed: May 30, 2008

(30) Foreign Application Priority Data
May 31, 2007 (JP) 2007-145060

(51) Int. Cl. H04N 5/217

(52) U.S. Cl. 348/251; 348/E05.078

(57) ABSTRACT

A solid-state imaging circuit is formed by including an imaging unit and an image processing unit. The imaging unit is formed by including a pixel array in which plural pixel circuits performing a photoelectric conversion of an optical image image-formed by a photographic optical system are arranged. The image processing unit performs a first shading correction using plural first correction factors having extreme-value positions at positions different from a position corresponding to an optical axis of the photographic optical system, for a two-dimensional image obtained by the imaging unit.

### CROSS-REFERENCE TO RELATED APPLICATION

This application is based upon and claims the benefit of priority from Japanese Patent Application No. 2007-145060, filed on May 31, 2007, the entire contents of which are incorporated herein by reference.

### BACKGROUND

1. Field

The present embodiment relates to a solid-state imaging circuit and a camera system, which may relate to a shading correction function of the solid-state imaging circuit.

2. Description of the Related Art

Recently, a solid-state imaging circuit is housed in various electronics devices such as a digital still camera and a portable terminal device. For example, as for the portable terminal device, miniaturization of a camera system is required, and therefore, the miniaturization of the solid-state imaging circuit mounted on the camera system is advancing, and an allowable area of a pixel array inside the solid-state imaging circuit becomes small. It is possible to realize a small-sized pixel array by making an area of a photodiode (photosensitive area) inside a pixel circuit forming the pixel array small, but desensitization of the pixel circuit occurs. Besides, not only the miniaturization of the solid-state imaging circuit but also miniaturization of a photographic lens is performed to realize the miniaturization of the camera system. If the photographic lens is miniaturized, an angle of incident light to a peripheral area of the pixel array in the solid-state imaging circuit from the photographic lens becomes large, and shading occurs. As a conventional art to solve the above-stated problem, a method providing a shading correction circuit performing a gain correction corresponding to the shading resulting from the photographic lens in an image processing unit of the solid-state imaging circuit is known. Besides, arts relating to a shading correction function are disclosed in, for example, Japanese Unexamined Patent Application Publication No. 2005-341033, Japanese Unexamined Patent Application Publication No. Hei 11-27526, and Japanese Unexamined Patent Application Publication No. 2006-253970.

### SUMMARY

It is an aspect of the embodiments discussed herein to provide a solid-state imaging circuit mounted on a camera system including an imaging unit having a pixel array in which plural pixel circuits performing a photoelectric conversion of an optical image image-formed by a photographic optical system are arranged, and an image processing unit performing a first shading correction using plural first correction factors having extreme-value positions at positions different from a position corresponding to an optical axis of the photographic optical system for a two-dimensional image obtained by the imaging unit. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is an explanatory view showing an embodiment.

FIG. 2 is an explanatory view (No. 1) showing problems of a pixel array having a 1×4 shared structure.

FIG. 3 is an explanatory view (No. 2) showing the problems of the pixel array having the 1×4 shared structure.

FIG. 4 is an explanatory view showing an example of first correction factors used in a shading correction processing of a Bayer data correction circuit.

FIG. 5 is an explanatory view showing an example of second correction factors used in the shading correction processing of the Bayer data correction circuit.

### DETAILED DESCRIPTION OF THE EMBODIMENTS

As for the solid-state imaging circuit used for the camera system of the portable terminal device and so on, it is necessary to make the area of the pixel array small so as to correspond to the miniaturization of the camera system. However, it becomes necessary to apply different formations for the pixel circuits disposed adjacently to secure a region of the photodiode in the pixel circuit forming the pixel array, in accordance with an advance of the miniaturization of the camera system. In the pixel array having the formation as stated above, an amount of the incident light varies up and down in adjacent rows, and therefore, shading resulting from the pixel array occurs in addition to the shading resulting from the photographic lens, and a position where an attenuation factor of the amount of the incident light becomes minimum (a position where the amount of the incident light becomes maximum) exists at a position different from a position corresponding to an optical axis of the photographic lens. In the shading correction of the conventional arts, it is assumed that the position where the attenuation factor of the amount of the incident light becomes minimum exists at the position corresponding to the optical axis of the photographic lens in the pixel array, and therefore, the shading resulting from the pixel array as stated above cannot be corrected appropriately.

Hereinafter, embodiments are described by using the drawings.

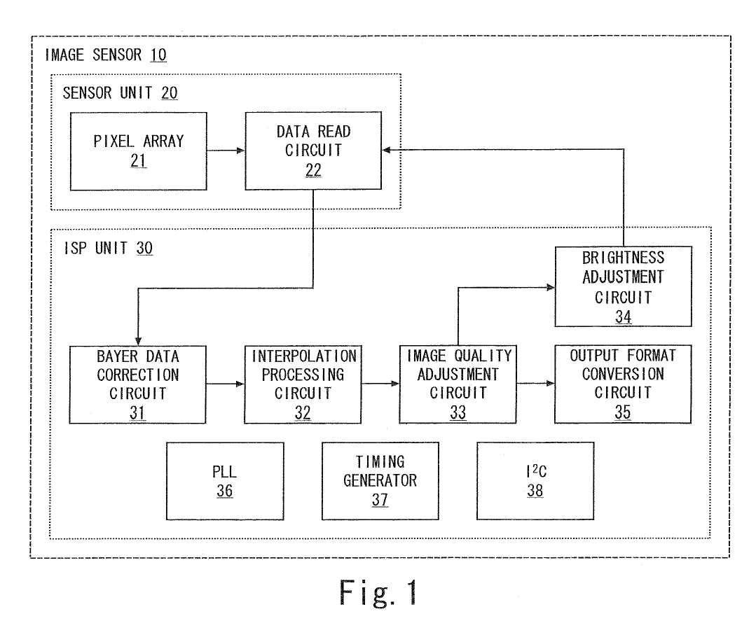

FIG. 1 shows an embodiment. In the embodiment, an image sensor 10 is applied to, for example, a camera system of a cellular phone handset. The image sensor 10 is formed by including a sensor unit 20 and an ISP (Image Signal Processing) unit 30. The sensor unit 20 is formed by including a pixel array 21 and a data read circuit 22. The pixel array 21 is formed by arranging plural pixel circuits performing a photoelectric conversion of an optical image image-formed by a photographic lens of the camera system in two dimensions. Incidentally, the pixel array 21 is formed by applying a well-known Bayer pattern. Besides, the pixel array 21 adopts, for example, a 1×4 shared structure (a structure in which common data read paths are provided by every four pixel circuits) on a purpose of miniaturization of the image sensor 10. The data read circuit 22 performs a CDS (Correlated Double Sampling) processing, an ADC (Analog-to Digital Conversion) processing, and so on for a data read out from the pixel array 21.

The ISP unit 30 is formed by including a Bayer data correction circuit 31, an interpolation processing circuit 32, an image quality adjustment circuit 33, a brightness adjustment circuit 34, an output format conversion circuit 35, a PLL (Phase Locked Loop) 36, a timing generator 37, and an 12C (inter Integrated Circuit) 38. The Bayer data correction circuit 31 performs a fault correction processing, a sensitivity correction processing, a shading correction processing, a noise filter processing, and so on for an output data (a Bayer data) of the data read circuit 22 in the sensor unit 20. The interpolation processing circuit 32 performs an RGB interpolation processing and so on for an output data (an RAW data) of the Bayer data correction circuit 31. The image quality adjustment circuit 33 performs a color adjustment processing, an AWB (Auto White Balance) processing, an edge emphasis processing, the noise filter processing, a gamma correction processing, and so on for an output data of the interpolation processing circuit 32. The brightness adjustment circuit 34 performs an AGC (Auto Gain Control) processing, a flicker cancel processing, and so on based on an output data of the image adjustment circuit 33, as a control processing for the data read circuit 22 in the sensor unit 20. The output format conversion circuit 35 performs a resolution conversion processing, a format conversion processing, and so on for the output data of the image quality adjustment circuit 33. For example, format conversions into a YUV422 format, a YCbCr format, an RGB565 format, and so on are possible at the output format conversion circuit 35. The PLL 36 generates a reference clock signal used inside the ISP unit 30. The timing generator 37 generates a timing signal defining operation timings of respective circuits in the ISP unit 30. The I²C 38 functions as an interface circuit with external devices. The present embodiment is applied mainly for a shading correction processing of the Bayer data correction circuit 31 in the image sensor 10 having the formation as stated above.

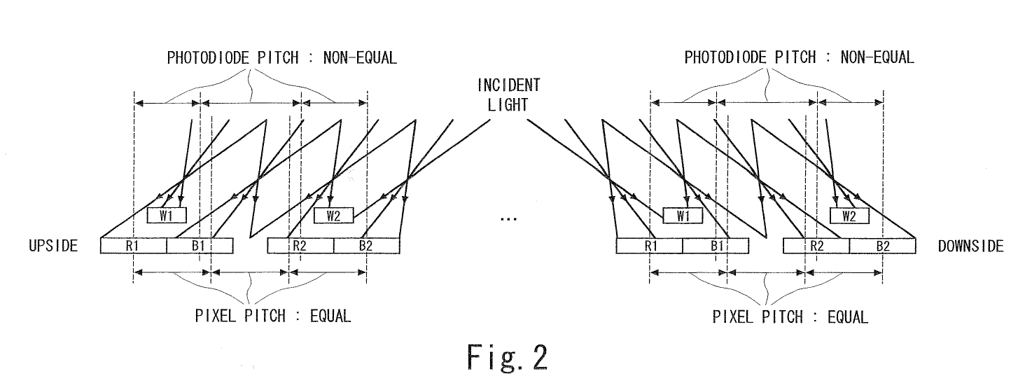

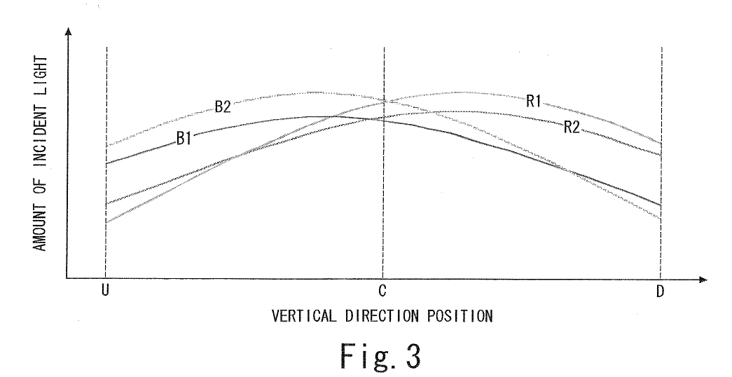

FIGS. 2 and 3 show problems of a pixel array having the 1×4 shared structure. When focusing on four pixel circuits (an R component pixel circuit having a photodiode R1, a B component pixel circuit having a photodiode B1, an R component pixel circuit having a photodiode R2, and a B component pixel circuit having a photodiode B2) adjacent in a vertical direction (longitudinal direction) in the pixel array 21 having the 1×4 shared structure, it has a formation in which positions of wires W1, W2 relative to the photodiodes are different, and a pixel pitch and a photodiode pitch are different, as it can be seen from FIG. 2. Accordingly, amounts of incident light to the photodiodes of the R component pixel circuits becomes different between the “i”-th RG row and the “i+1”-th RG row. Besides, a displacement between the photodiode pitch and the pixel pitch exists also in a vicinity of a center of the pixel array 21 (a position corresponding to an optical axis of the photographic lens), and therefore, the difference occurs in the amounts of the incident light to the photodiodes.

Accordingly, relations between the amounts of the incident light to the photodiodes R1, R2 of the R component pixel circuits and vertical direction positions of the pixel array 21 become as shown in FIG. 3 when an upside boundary U, a center C, and a downside boundary D of the pixel array 21 are used, and positions where attenuation factors of the amount of the incident light become minimum (positions where the amounts of the incident light become maximum) displace from the center C of the pixel array 21. A phenomenon as stated above arises similarly for the amounts of the incident light to the photodiodes B1, B2 of the B component pixel circuits at a GB row, but positions where the attenuation factors of the amounts of the incident light become minimum exist at an opposite side of the amounts of the incident light to the photodiodes R1, R2 of the R component pixel circuits at the RG row relative to the center C of the pixel array 21 resulting from the formation of the pixel array 21.

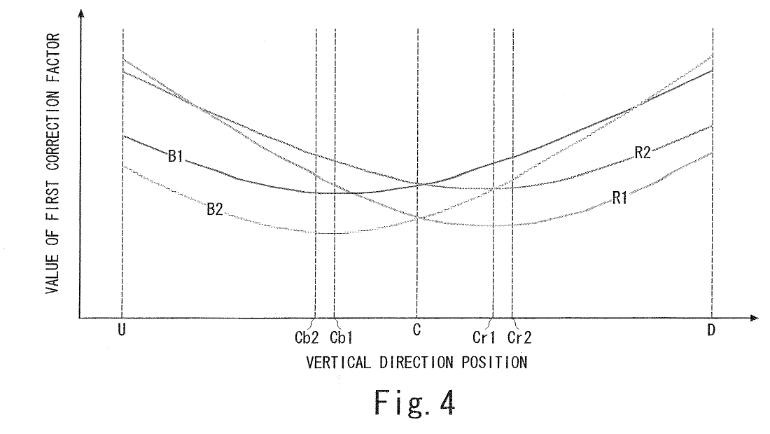

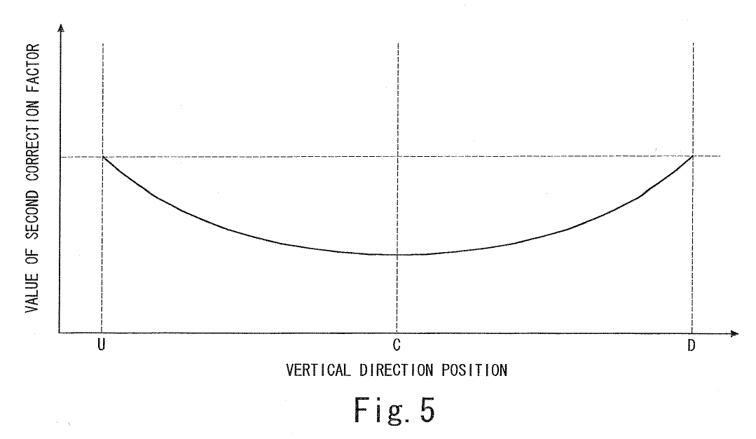

FIG. 4 shows an example of first correction factors used in the shading correction processing of the Bayer data correction circuit. FIG. 5 shows an example of second correction factors used in the shading correction processing of the Bayer data correction circuit. In the shading correction processing of the Bayer data correction circuit 31, a first shading correction processing using plural first correction factors is performed to correct the shading resulting from the pixel array 21 having a tendency as stated above. As for the first correction factors, offsets of extreme-value positions relative to a center of a two-dimensional image (a position corresponding to the optical axis of the photographic lens) can be set by each column of the two-dimensional image corresponding to the output data of the data read circuit 22. Besides, the offsets of the extreme-value positions relative to the center of the two-dimensional image can be set by each color component of the two-dimensional image as for the first correction factors. Further, the first correction factors can be set in asymmetry relative to the extreme-value positions. For example, when the shading resulting from the pixel array 21 as shown in FIG. 3 is corrected, a relation between values of the first correction factors used in the shading correction processing and the vertical direction positions of the two-dimensional image becomes as shown in FIG. 4 when an upside boundary U, a center C, and a downside boundary D of the two-dimensional image are used. The vertical direction position of the two-dimensional image corresponding to the vertical direction position of the pixel array 21 where the attenuation factor of the amount of the incident light to the photodiode R1 (R2) becomes minimum is set as an extreme-value position Cr1 (Cr2), as for the first correction factors corresponding to the R component pixel circuit having the photodiode R1 (R2). Similarly, the vertical direction position of the two-dimensional image corresponding to the vertical direction position of the pixel array 21 where the attenuation factor of the amount of the incident light to the photodiode B1 (B2) becomes minimum is set as an extreme-value position Cb1 (Cb2), as for the first correction factors corresponding to the B component pixel circuit having the photodiode B1 (B2). The first shading correction processing as stated above is performed, and thereby, the shading resulting from the pixel array 21 is corrected appropriately.

Besides, as for the shading resulting from the photographic lens, the attenuation factor of the amount of the incident light to the pixel array 21 becomes minimum at the center of the pixel array 21, and it becomes in symmetry relative to the center of the pixel array 21. Besides, as for the shading resulting from the photographic lens, a difference by each color component does not exist in the attenuation factor of the amount of the incident light to the pixel array 21. In the shading correction processing of the Bayer data correction circuit 31, a second shading correction processing using plural second correction factors is also performed to correct the shading resulting from the photographic lens having a tendency as stated above. As for the second correction factors, the center of the two-dimensional image is set as the extreme-value position, and they are set to be in symmetry relative to the center of the two-dimensional image. For example, a relation between values of the second correction factors used in the shading correction processing and the vertical direction positions of the two-dimensional image becomes as shown in FIG. 5 when the upside boundary U, the center C, and the downside boundary D of the two-dimensional image are used. The second shading correction processing as stated above is performed, and thereby, the shading resulting from the photographic lens is corrected appropriately.

In the embodiment as stated above, the first and second shading correction processings are performed, and thereby, it becomes possible to correct both the shading resulting from the pixel array 21 and the shading resulting from the photographic lens appropriately, and to eliminate color shading in a photographic image. Accordingly, it is possible to largely contribute to improve a performance and to realize a miniaturization of the image sensor 10.

Incidentally, in the above-stated embodiment, an example in which the offsets of the extreme-value positions relative to the center of the two-dimensional image can be set by each column of the two-dimensional image as for the first correction factors is described, but the offsets of the extreme-value positions relative to the center of the two-dimensional image may be made settable by each row of the two-dimensional image as for the first correction factors, depending on the formation of the pixel array.

A proposition of the aforementioned embodiment is to appropriately correct the shading resulting from the pixel array.

In an aspect of the embodiment, a solid-state imaging circuit mounted on a camera system is formed by including an imaging unit having a pixel array and an image processing unit. The pixel array is formed by arranging plural pixel circuits performing a photoelectric conversion of an optical image image-formed by a photographic optical system. Besides, the pixel array is formed by providing common data output paths by every predetermined number of pixel circuits. The image processing unit performs a first shading correction using plural first correction factors having extreme-value positions at the positions different from a position corresponding to an optical axis of the photographic optical system, for a two-dimensional image obtained by the imaging unit. The extreme-value positions of the plural first correction factors can be set by each row or by each column of the two-dimensional image. The extreme-value positions of the plural first correction factors can be set by each color component of the two-dimensional image. The plural first correction factors can be set in asymmetry relative to the extreme-value positions. Besides, the image processing unit performs a second shading correction using plural second correction factors having an extreme-value position at a position corresponding to the optical axis of the photographic optical system in addition to perform the first shading correction, for the two-dimensional image. The plural second correction factors are in symmetry relative to the extreme-value position. The first shading correction is a shading correction concerning a shading resulting from the pixel array. The second shading correction is a shading correction concerning a shading resulting from the photographic optical system. According to the formation as stated above, it is possible to correct both the shading resulting from the pixel array and the shading resulting from the photographic optical system appropriately. Accordingly, it is possible to largely contribute to improve a performance and to decrease a circuit scale of the solid-state imaging circuit.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A solid-state imaging circuit, comprising:
an imaging unit having a pixel array in which plural pixel circuits performing a photoelectric conversion of an optical image image-formed by a photographic optical system are arranged; and
an image processing unit performing a first shading correction using plural first correction factors having extreme-value positions at positions different from a position corresponding to an optical axis of the photographic optical system, for a two-dimensional image obtained by the imaging unit.

2. The solid-state imaging circuit according to claim 1, wherein
the extreme-value positions of the plural first correction factors are able to be set by each row or by each column of the two-dimensional image.

3. The solid-state imaging circuit according to claim 1, wherein
the extreme-value positions of the plural first correction factors are able to be set by each color component of the two-dimensional image.

4. The solid-state imaging circuit according to claim 1, wherein
the plural first correction factors are able to be set in asymmetry relative to the extreme-value positions.

5. The solid-state imaging circuit according to claim 1, wherein
the pixel array is formed by providing common data output paths by every predetermined number of pixel circuits.

6. The solid-state imaging circuit according to claim 1, wherein
the image processing unit performs a second shading correction using plural second correction factors having an extreme-value position at a position corresponding to the optical axis of the photographic optical system in addition to perform the first shading correction, for the two-dimensional image.

7. The solid-state imaging circuit according to claim 6, wherein
the plural second correction factors are in symmetry relative to the extreme-value position.

8. The solid-state imaging circuit according to claim 6, wherein
the first shading correction is a shading correction concerning a shading resulting from the pixel array, and
the second shading correction is a shading correction concerning a shading resulting from the photographic optical system.

9. A camera system including a solid-state imaging circuit, wherein the solid-state imaging circuit includes:
an imaging unit having a pixel array in which plural pixel circuits performing a photoelectric conversion of an optical image image-formed by a photographic optical system are arranged; and
an image processing unit performing a first shading correction using plural first correction factors having extreme-value positions at positions different from a position corresponding to an optical axis of the photographic optical system, for a two-dimensional image obtained by the imaging unit.

10. The camera system according to claim 9, wherein
the extreme-value positions of the plural first correction factors are able to be set by each row or by each column of the two-dimensional image.

11. The camera system according to claim 9, wherein
the extreme-value positions of the plural first correction factors are able to be set by each color component of the two-dimensional image.

12. The camera system according to claim 9, wherein
the plural first correction factors are able to be set in asymmetry relative to the extreme-value positions.

13. The camera system according to claim 9, wherein
the pixel array is formed by providing common data output paths by every predetermined number of pixel circuits.

14. The camera system according to claim 9, wherein
the image processing unit performs a second shading correction using plural second correction factors having an extreme-value position at a position corresponding to the optical axis of the photographic optical system in addition to perform the first shading correction, for the two-dimensional image.

15. The camera system according to claim 14, wherein
the plural second correction factors are in symmetry relative to the extreme-value position.

16. The camera system according to claim 14, wherein
the first shading correction is a shading correction concerning a shading resulting from the pixel array, and
the second shading correction is a shading correction concerning a shading resulting from the photographic optical system.
